(19) United States
(12) Patent Application Publication
(10) Pub. No.: US 2017/0215648 A1
(43) Pub. Date: Aug. 3, 2017

(54) Hand-Held Tool for Compressing Contents of Food Cans

(71) Applicant: W. Kirk Lybarger, Lakeside, CA (US)

(72) Inventor: W. Kirk Lybarger, Lakeside, CA (US)

(21) Appl. No.: 15/422,366

(22) Filed: Feb. 1, 2017

Related U.S. Application Data
(60) Provisional application No. 62/289,494, filed on Feb. 1, 2016.

(51) Int. Cl. A47J 43/28; B30B 1/20

(52) U.S. Cl. CPC A47J 43/286; B30B 1/20

(57) ABSTRACT

A tool for compression of food within food cans is provided having a handle engaged with a body with first and second supports. A threaded member engaged with a first support when rotated translates a contact member against a lid of a can on a support surface of the opposing second support to compress food in the can between a lid and the bottom of the can. The tool can in include a plurality of contact members sized to engage different diameter sized cans.

This application claims priority to U.S. Provisional Patent Application Ser. No. 62/289,494, filed on Feb. 1, 2016, which is incorporated herein in its entirety by this reference thereto.

### BACKGROUND OF THE INVENTION

1. Field of the Invention

The present invention relates to drainage of fluid from canned foods. More particularly, it relates to a hand-held tool adapted for engagement to a plurality of different sized cans to enable the user to compress the can lid against the contents and remove excess fluid. The device includes an exterior adapted to support the can and tool on a counter surface during use to allow the user to impart their strength solely to compression of the food during use.

2. Prior Art

A modern era convenience of canned food has allowed buyers around the globe to purchase food which is sealed within a metal can and which remains edible for very long durations of time. However, many canned foods such as tuna, salmon, shrimp, and other foods, include a volume of liquid which is packed within the can along with the food product. For many users, this liquid is something which should be removed prior to ingesting the food packed within the can.

A conventional means of accomplishing this fluid and food separation is for the user to open the top of the can, and then invert it over a drain and wait for the fluid to drain from the can. Users who wish to drain even more fluid, will manually press the lid into the cavity within the can while inverting the can, and thus press upon the food to force fluid to drain.

These conventional means for fluid drainage for canned foods have a number of disadvantages. First, the lid of a can during removal tends to develop very sharp edges. A user compressing this lid into the cavity of the can, can easily suffer a serious cut. Additionally, the liquid contained in many food cans can have a very strong odor such as fish oil in a tuna or salmon can. When this liquid contacts the hand of the user, it tends to impart the smell to the user.

Still further, users pressing the can lid into the food cavity of a can, also communicate areas of their hand and fingers into the cavity holding the food. This contact of the body of the user with the food, can cause germs and bacteria on the hand of the user, to contaminate the food.

An additional problem, encountered by many users, is a lack of the required dexterity and strength to press the lid into the can cavity. Such requires the user to hold the can elevated and inverted over a drain, and then use the fingers and thumb to impart force to compress the food in the can and cause drainage. Many users lack the strength to handle either elevating the weight of the can or compressing the lid, and even those with the strength to do so, will find it difficult to handle all three actions at once.

As such, there is a continuing unmet need for an improved tool which is configured for engaging a food can and concurrently compressing the lid against the food within the can cavity. Such a device should be light weight, yet provide the user with sufficient mechanical advantage, to enable users with less hand strength to effectively compress and drain liquid from the food in the can.

Further, because such canned foods come in a variety of standard yet differing sizes, such a liquid drain tool should be adapted to be engageable to a plurality of can diameters and thereby allow use on more than one sized can. Additionally, such a device should be configured to allow the user to support the tool and engaged can upon or against a planar surface to help support the can while the user is imparting force to the tool to drain liquid therefrom.

The forgoing examples of related art in can drainage, and limitation related therewith are intended to be illustrative and not exclusive, and they do not imply any limitations on the tethering invention described and claimed herein. Various limitations of the related art of the provision of tool engaging mounts will become apparent to those skilled in the art upon a reading and understanding of the specification below and the accompanying drawings.

### SUMMARY OF THE INVENTION

The device and method herein disclosed and described achieves the above mentioned goals through the provision of a hand-held tool configured for operative engagement with one or a plurality of differing cans for food having differing diameters and heights. The device so engaged provides mechanical advantage during hand operation to compress the can lid into the food within the can, to drain fluid therefrom. The device features a body portion having a handle extending therefrom adapted for gripping by the user during use.

The body portion features a planar support surface for positioning of the can thereon. The support surface is preferably adapted to support a bottom surface of one or a plurality of different diameter cans during use, and hold the supported can centered. A support member portion of the body, is spaced apart from and overhangs the support surface. The support member is configured with a threaded aperture which engages a threaded member defining a compression component. Planar portions of the support surface are each surrounded by an elevated area about a perimeter of the area of each support surface, sized to maintain the center of a can aligned with a center of the threaded aperture.

At a first end of the threaded member providing for imparting force for compression to the lid into the can is located a handle which is adapted in shape for engagement between the fingers and thumb of the user during operation of the device to remove fluid from the can. As shown, winged portions extending from the center of the handle, are positioned for contact with the hand of a user. A twisting of the handle will impart rotation of the threaded member within the threaded aperture, and cause the member to translate toward the support surface.

At a second end of the threaded member, opposite the handle, is located a contact member which is sized to contact against a disconnected lid of the can to force the lid into the food cavity of the can in a direction toward the bottom of the can. In one mode of the device herein, the contact member is planar on a side contacting the can, and of a size and shape to contact a majority of the surface of a can lid during compression thereof into the can. In another preferred mode of the device herein, each contact member from a plurality is removably engaged to the distal end of the threaded member, opposite the handle thereon. In this mode at least two such contact members are provided which are of two different diameters. Each diameter is configured to engage upon a different sized lid of a different sized can.

The engagement of the contact member with the threaded member is, in the preferred mode, a rotational engagement where the end of the threaded member rotates in its engagement with the contact member. This helps to lower the force needed to twist the threaded member making the device easier to use.

The support surface is adapted to contact the lower surface of the can and maintain the center of the can inline with the axis of the threaded member. This effectively registers the can in a centered engagement with an engaged contact member on the distal end of the threaded member. Such is also preferred to maximize the mechanical advantage of the device during use for the user.

In the mode of the device with a plurality of at least two contact members, each will have a differing diameter adapted to mate with a lid of a different sized can. Each contact member is adapted at a center area to operatively engage with the distal end of the threaded member, and also with an attachment point on the lower surface of the body of the device.

In one mode this may be a threaded engagement of the distal end of the threaded member with both the contact member and the body. Such includes a threaded aperture which is configured to removably engage on both of an attachment point at the distal end of the threaded member, and an attachment point on a lower surface of the tool body. In another mode of the device, the distal end of the threaded member is rotationally engaged with a race formed on the contact member, and the contact member engages with the bottom of the body, either magnetically or by connecting to a mating position configured to engage the race.

In all modes of the device, the contact member, when attached to the lower surface of the body, has the center of the contact member preferably maintained in line with the axis of the threaded member. This is preferable because the contact member, engaged to the lower surface of the body of the device, provides an enlarged area for contact with a planar support surface during use, such as a countertop or table. The centering of the second contact member with the axis of the threaded member, helps balance the device for the user during operation when engaged with a can during compression thereof.

Also in a preferable mode of the device, a portion of the threaded member at the distal end, is threadless and has a smooth circumferential surface sized to slide through the threaded aperture of the body. This allows the user to slide the threaded member until the contact member is on or adjacent the lid of the can, and then rotate the threaded member to an engagement with the threads. Such was found unexpectedly during experimentation to make the device faster and easier to use for users, as opposed to the threaded member with threads continuing to the distal end.

With respect to the above description, before explaining at least one preferred embodiment of the herein disclosed compression tool for a food can in detail, it is to be understood that the invention is not limited in its application to the details of construction and to the arrangement of the components in the following description or illustrated in the drawings. The invention herein described is capable of other embodiments and of being practiced and carried out in various ways which will be obvious to those skilled in the art. Also, it is to be understood that the phraseology and terminology employed herein are for the purpose of description and should not be regarded as limiting.

As such, those skilled in the art will appreciate that the conception upon which this mounting system is based, may readily be utilized as a basis for designing of other such can compression tools and for carrying out the several purposes of the present disclosed device. It is important, therefore, that the claims be regarded as including such equivalent construction and methodology insofar as they do not depart from the spirit and scope of the present invention.

It is one principal object of this invention to provide an easy to use compression tool to drain fluid from food cans.

It is an additional object of this invention to provide such a tool to compress food within food cans which is configurable for engagement to a plurality of food cans of differing diameters and still yield maximum mechanical advantage during use.

These together with other objects and advantages which become subsequently apparent reside in the details of the construction and operation as more fully hereinafter described and claimed, reference being had to the accompanying drawings forming a part thereof, wherein like numerals refer to like parts throughout.

### BRIEF DESCRIPTION OF DRAWING FIGURES

FIG. 1 depicts a side view of the canned food compression device in an as-used configuration, having a body with a planar bottom edge adapted for positioning on a counter and a downward angled handle extending from the body, and showing the positioning of a food can for compression of the lid by rotation of a threaded member to compress a contact member against the can lid.

FIG. 2 depicts an overhead perspective view of the device of FIG. 1.

FIG. 3 shows another preferred mode of the compression device herein having a plurality of engageable contact members which are removably engageable and switchable to provide a contact member for maximizing communication area against lids of smaller or larger cans.

FIG. 4 is a bottom perspective view of the device of FIG. 3 showing the central engagement point of the contact members with either the distal end of the threaded member or a mount extending from a lower surface of the body.

FIG. 5 depicts a side view of another preferred mode of the device, showing a side view thereof.

FIG. 6 shows a lower perspective view of the device as in FIG. 5 and also shows the slide on engagement of the support surface for the can with the body, and magnetic components on the body, handle and contact member.

FIG. 7 shows an overhead perspective view of the device as in FIG. 6.

FIG. 8 depicts the threaded member showing a leading surface sized to slide through the threaded aperture of the body, to position the contact member adjacent the lid of a can.

### DETAILED DESCRIPTION OF THE PREFERRED EMBODIMENTS OF THE INVENTION

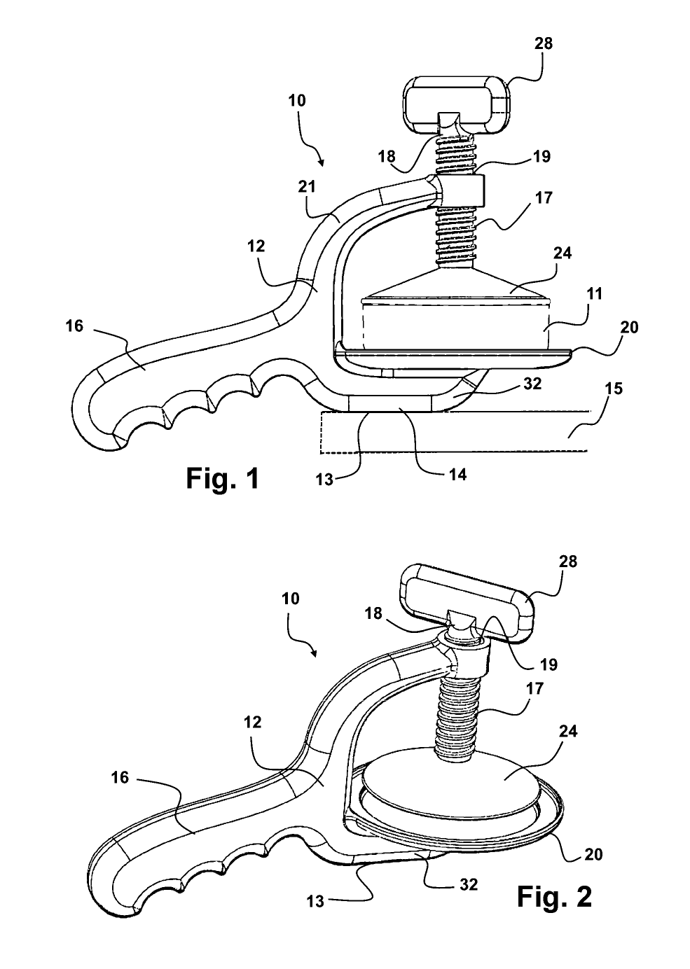

Referring now to the drawings of FIGS. 1-8 depicting the device 10 herein, showing various views thereof, similar components of the device 10 are labeled with the same numerals throughout the description herein.

As can be seen in FIG. 1, which is a side view of the device 10 depicting it as it will function in an as-used configuration, in operative compressive engagement with a food can 11. The device 10 in all modes has a body 12 which has a planar portion 13 on a lower surface 14 which is adapted for contact with a planar support surface during use, such as a counter 15, to better support the device 10 during such use.

Preferred in all modes of the device 10, is the provision of a downward angled handle 16, relative to the planar portion 13, such that the distal end of the handle 16, is positioned below the counter 15 supporting the device 10 during use. It has been found, during experimentation, that a linear or straight handle 16 will work, and the device 10 could be so configured, but the downward angle makes the device more comfortable for the user to grip the handle 16 when the device 10 is supported on a planar surface or counter 15.

As can be seen in all modes, the device 10 is adapted for a can 11 to be positioned upon the support surface 20 on the body 14. A first support area 21 is sized to support the lower surface of the can 11, in a registered position. If the device 10 is configured for use with a single size of can 11, then only the first support area 21 would be provided. The device 10 is configured to preferably position the can 11 with its center aligned with an axis of a threaded member 18, which provides the mechanical advantage to compress the can lid, into the can 11.

This registered centered positioning can be provided by the first support surface 21 with a ridge 23 surrounding it, which forms the first support surface 21 in a recess. Alternatively, or in combination, the circumference of the contact member 24, used to press the lid of the can 11, is formed slightly smaller than the circumference of the can 11, such that it will center within a conventional lip of the can 11 surrounding the lid thereof.

In all modes, rotation of the threaded member 18 by turning a handle 28 thereon, will rotate threads 17 formed thereon in the engagement with the threaded aperture 19 formed into a support member 15 of the body 12. This threaded aperture 19 is located on the support member 15 directly across a gap from the center of the support surface 20.

In all modes of the device 10, during rotation of the threaded member 18, the distal end of the threaded member 18 which is connected to the contact member 24, will force the contact member to translate toward the bottom of the can 11. The engagement of the threaded member 18 with a threaded aperture 19, and resulting rotation thereof, provide significant mechanical advantage for the user to compress food in the can 11.

Additionally, unlike plier type compressors, the compression of the food is maintained until the user rotates the threaded member 18 the opposite direction and disengages the contact member 24.

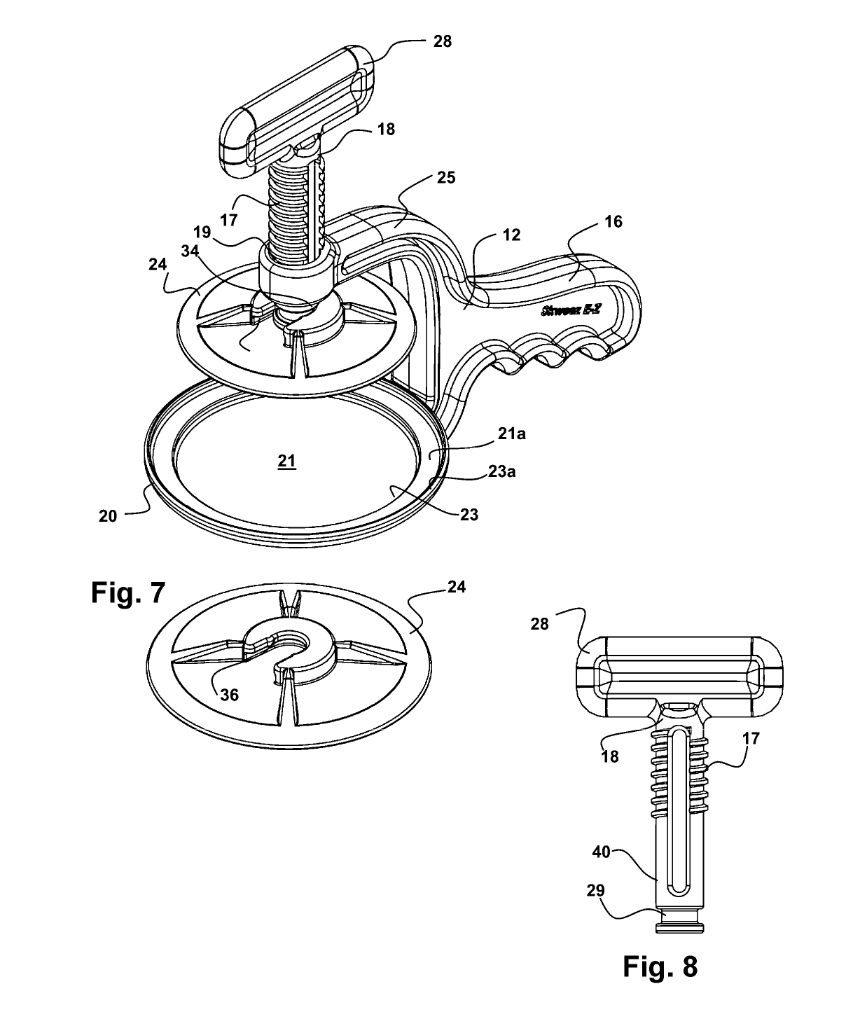

Also shown in FIGS. 2 and 7, are a second surface area 21a, adapted to support a can 11 having a circumference larger than a can 11 positioned in the first surface area 21. This is especially preferred in the device 10 herein, as it allows the user to employ the device 10 compress two differently sized cans 11. Where the second surface area 21a is provided, it surrounds the first surface area 21. As depicted, a second ridge 23a surrounds this second surface area 21a, and the second surface area 21a is at a higher elevation than the first surface area 21, and joined thereto by a sidewall forming the first ridge 23 surrounding the first surface area 21. The plurality of surface areas adapted to support differently sized cans 11 is shown as two, which works well, but could be more if compression of more can 11 sizes is desirable.

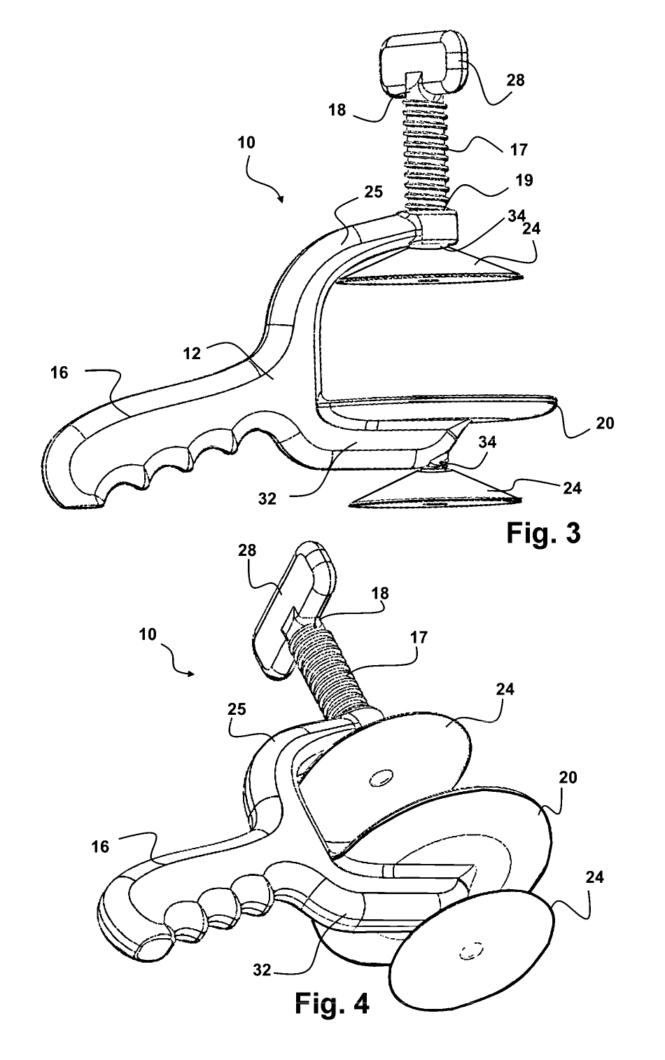

Shown in FIGS. 3-5, is another particularly preferred mode of the device 10, which includes additional utility to the user. In this mode of the device 10, a plurality of removably engageable contact members 24 are provided the user. Each of the contact members 24 is adapted to operatively removably engage both, a mount 34 at the distal end of the threaded member 18, and a mount 34 on the lower surface 14 of the body 12. The user can then choose to engage the contact member 24 with the smaller or larger diameter defining a circumference best matching that of the can 11 inserted. An additional benefit of having a contact member 24 engaged with the bottom of the lower surface 14, is that it provides a larger surface area for the user to support the device 10 on a counter 15 or sink or other surface, and because it is wider, it helps prevent tipping.

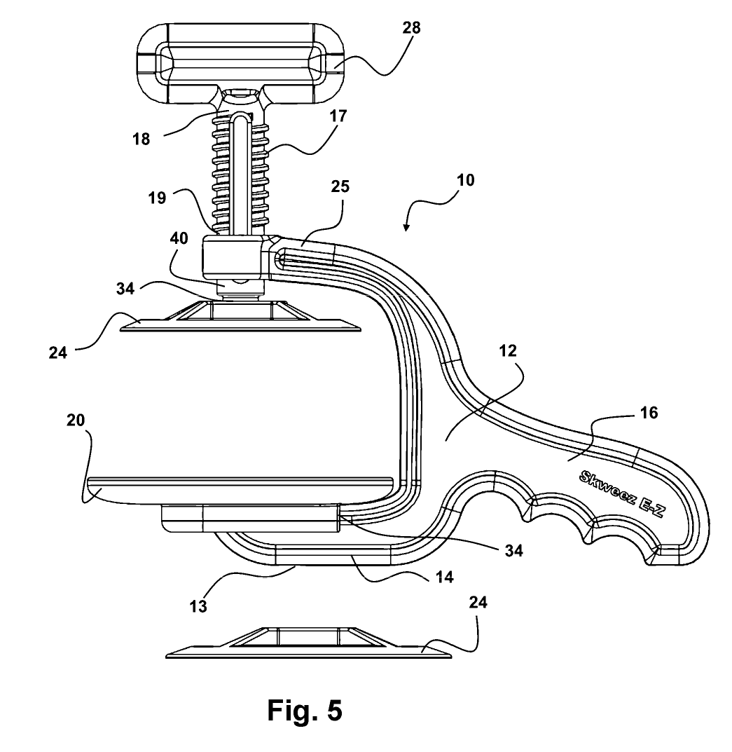

FIGS. 5-8 depict views of another preferred mode of the device 10. As shown the device 10 is configured to employ a plurality of two contact members 24 having progressively larger diameters. The contact member 24 of the plurality which is not in engagement to the threaded member 18, such as in FIG. 5, is engageable to the lower surface 14 of the body 12 using complimentary fasteners located on each. Currently preferred complimentary fasteners include a projection similar in shape to the distal end of the threaded member 18 of FIG. 8, having a recess forming a race 29, or using a magnetic attraction between a magnet 30 on the contact member 24 and the lower surface 14 of the body 12.

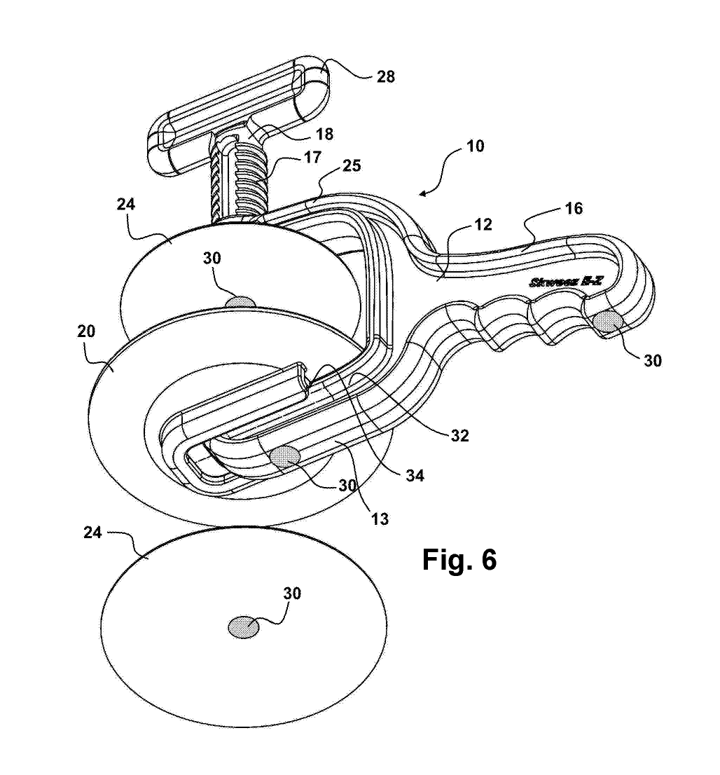

Shown in FIG. 6, in a lower perspective view of the device as in FIGS. 5-8, is a slide-on engagement of the support surface 20 for a can 11, to a second support member 32 of the body 12 extending opposite the first support member 21. As shown, a bearing 36 formed on the lower surface of the support surface 20, is sized to frictionally engage upon the distal end of the second support member 32.

In FIG. 7 is depicted an overhead perspective view of the device 10 of FIGS. 5-8. Shown is a preferred connection of the contact member 24, to the distal end of the threaded member 18. As shown, a bearing 36 is formed on the top or first surface of the contact member 24 which is opposite a contacting surface which contacts the lid of a can 11 when used to compress it. This bearing 36 allows for a rotational engagement with the race 29 (FIG. 8) when the threaded member 18 is rotated, such as by twisting a handle 28 formed at a first end of the threaded member 18. Such is particularly preferred as it lessens the force needed to rotate the threaded member 18 once the contact member 24 is in compressive engagement with the lid of a can 11.

Finally, as shown in FIG. 8, particularly preferred in all modes of the device 10 herein in FIGS. 1-7, is the positioning of a smooth surface portion 40 upon the circumference of the threaded member 18 extending from a central portion of the threaded member 18 to the distal end which engages with the contact member 24. As noted, it was found during experimentation, that forming the smooth surface portion 40 with a diameter sized to slide through the threaded aperture 19, allows the user to slide the engaged contact member 24 to a position adjacent the can 11 more easily and quickly. Further, once the lid of the can 11 has been compressed to its fullest, and the threaded member 18 rotated to disengage the threads 17 from the threaded aperture 19, it allows the user to easily pull the contact member from the top side of the can 11.

This sliding configuration of the distal end to the mid portion of the threaded member 18 afforded by the smooth surface portion 40, where magnets 30 are positioned on the contact member 24, allows the user to pull lids of cans 11 which are magnetically attractive, away from the top of the can 11 quickly, and remove the can 11 from the support surface 20. Additional utility is provided by the depicted magnets 30 on the body 12, since the magnets 30 can removably engage a magnetically attractive surface in the kitchen or room, and hold the device 10 in between uses.

While all of the fundamental characteristics and features of the disclosed tool for compressing food within a can for fluid removal have been shown and described herein, with reference to particular embodiments thereof, a latitude of modification, various changes and substitutions are intended in the foregoing disclosure and it will be apparent that in some instances, some features of the invention may be employed without a corresponding use of other features without departing from the scope of the invention as set forth. It should also be understood that various substitutions, modifications, and variations may be made by those skilled in the art without departing from the spirit or scope of the invention. Consequently, all such modifications and variations and substitutions are included within the scope of the invention as defined by the following claims.

What is claimed is:

1. A tool for compression of food within food cans comprising:
a body having a first support member positioned across a gap from a second support member;
a support surface on said second support member, said support surface adapted for positioning of a food can thereon;
a threaded aperture formed in said first support member;
a threaded member having a first end and having a distal end opposite said first end;
said threaded member having threads around a circumference thereof in-between said first end and said distal end, said threads cooperatively engageable with said threaded aperture;
a contact member in an engagement at said distal end of said threaded member, said contact member having a diameter adapted to contact a lid of said can;
said threaded member rotatable in a first direction translating said contact member toward said support surface; and
said threaded member rotatable in a second direction translating said contact member in a direction toward said first support member, whereby a rotation of said threaded member in said first direction imparts a compression to food positioned with said can between a bottom surface of said food can and said lid.

2. The tool for compression of food within food cans of claim 1, wherein said engagement of said contact member at said distal end of said threaded member is a rotational engagement between said threaded member and said contact member.

3. The tool for compression of food within food cans of claim 1 additionally comprising:
a plurality of said contact members; and
said engagement of said contact member at said distal end of said threaded member is a removable engagement between said threaded member, and any of said plurality of contact members.

4. The tool for compression of food within food cans of claim 1 additionally comprising:
said engagement of said contact member at said distal end of said threaded member, comprises a race located adjacent said distal end of said threaded member in an engagement with a bearing located on said contact member.

5. The tool for compression of food within food cans of claim 2 additionally comprising:
said rotational engagement of said contact member at said distal end of said threaded member, comprises a race located adjacent said distal end of said threaded member in an engagement with a bearing located on said contact member.

6. The tool for compression of food within food cans of claim 3 additionally comprising:
said rotational engagement of said distal end of said threaded member, with each of said plurality of contact members, comprises a race located adjacent said distal end of said threaded member which is removably engageable with a bearing located on each respective contact member of said plurality of contact members.

7. The tool for compression of food within food cans of claim 4 additionally comprising:
said rotational engagement of said distal end of said threaded member, with each of said plurality of contact members, comprises a race located adjacent said distal end of said threaded member which is removably engageable with a bearing located on each respective contact member of said plurality of contact members.

8. The tool for compression of food within food cans of claim 1 additionally comprising:
said support surface having a first surface area adapted for positioning of a first said food can thereon; and
said support surface having a second surface area surrounding said first surface area, said second surface area adapted for positioning of a second said food can thereon which is larger in diameter than said first food can.

9. The tool for compression of food within food cans of claim 2 additionally comprising:
said support surface having a first surface area adapted for positioning of a first said food can thereon; and
said support surface having a second surface area surrounding said first surface area, said second surface area adapted for positioning of a second said food can thereon which is larger in diameter than said first food can.

10. The tool for compression of food within food cans of claim 3 additionally comprising:
said support surface having a first surface area adapted for positioning of a first said food can thereon; and
said support surface having a second surface area surrounding said first surface area, said second surface area adapted for positioning of a second said food can thereon which is larger in diameter than said first food can.

11. The tool for compression of food within food cans of claim 4 additionally comprising:
said support surface having a first surface area adapted for positioning of a first said food can thereon; and
said support surface having a second surface area surrounding said first surface area, said second surface area adapted for positioning of a second said food can thereon which is larger in diameter than said first food can.

12. The tool for compression of food within food cans of claim 5 additionally comprising:
said support surface having a first surface area adapted for positioning of a first said food can thereon; and
said support surface having a second surface area surrounding said first surface area, said second surface area adapted for positioning of a second said food can thereon which is larger in diameter than said first food can.

13. The tool for compression of food within food cans of claim 7 additionally comprising:
said support surface having a first surface area adapted for positioning of a first said food can thereon; and
said support surface having a second surface area surrounding said first surface area, said second surface area adapted for positioning of a second said food can thereon which is larger in diameter than said first food can.

14. The tool for compression of food within food cans of claim 1 additionally comprising:
a smooth surface portion of said circumference of said threaded member extending from said distal end to a mid portion of said threaded member; and
said circumference of said threaded member along said smooth portion being slideable through said threaded aperture.

15. The tool for compression of food within food cans of claim 2 additionally comprising:
a smooth surface portion of said circumference of said threaded member extending from said distal end to a mid portion of said threaded member; and
said circumference of said threaded member along said smooth portion being slideable through said threaded aperture.

16. The tool for compression of food within food cans of claim 3 additionally comprising:
a smooth surface portion of said circumference of said threaded member extending from said distal end to a mid portion of said threaded member; and
said circumference of said threaded member along said smooth portion being slideable through said threaded aperture.

17. The tool for compression of food within food cans of claim 4 additionally comprising:
a smooth surface portion of said circumference of said threaded member extending from said distal end to a mid portion of said threaded member; and
said circumference of said threaded member along said smooth portion being slideable through said threaded aperture.

18. The tool for compression of food within food cans of claim 3 additionally comprising:
said plurality of contact members being a plurality of two;
a mount positioned on said support member on an opposite side from said support surface; and
said mount configured to removably engage with one of said contact members.

19. The tool for compression of food within food cans of claim 4 additionally comprising:
said plurality of contact members being a plurality of two;
a mount positioned on said support member on an opposite side from said support surface; and
said mount configured to removably engage with one of said contact members.

20. The tool for compression of food within food cans of claim 17 additionally comprising:
said plurality of contact members being a plurality of two;
a mount positioned on said support member on an opposite side from said support surface; and
said mount configured to removably engage with one of said contact members.
